(19) United States
(12) Patent Application Publication
(10) Pub. No.: US 2005/0078869 A1
(43) Pub. Date: Apr. 14, 2005

(54) Method for feature extraction using local linear transformation functions, and method and apparatus for image recognition employing the same

(75) Inventor: Tae-kyun Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/896,991

(22) Filed: Jul. 23, 2004

(30) Foreign Application Priority Data
Jul. 28, 2003 (KR) 2003-52131

(51) Int. Cl. G06K 9/36; G06K 9/66; G06K 9/46

(52) U.S. Cl. 382/190; 382/276

(57) ABSTRACT

A method of extracting feature vectors of an image by using local linear transformation functions, and a method and apparatus for image recognition employing the extracting method. The method of extracting feature vectors by using local linear transformation functions includes: dividing learning images formed with a first predetermined number of classes, into a second predetermined number of local groups, generating and storing a mean vector and a set of local linear transformation functions for each of the divided local groups comparing input image vectors with the mean vector of each local group and allocating one of the local groups to the input image; and extracting feature vectors by vector-projecting the local linear transformation functions of the allocated local group on the input image. According to the method, the data structure that has many modality distributions because of a great degree of variance with respect to poses or illumination is divided into a predetermined number of local groups, and a local linear transformation function for each local group is obtained through learning. Then, by using the local linear transformation functions, feature vectors of registered images and recognized images are extracted such that the images can be recognized with higher accuracy.

### CROSS-REFERENCE TO RELATED APPLICATIONS

This application claims the priority of Korean Patent Application No. 2003-52131, filed on Jul. 28, 2003 in the Korean Intellectual Property Office, the disclosure of which is incorporated herein in its entirety by reference.

### BACKGROUND OF THE INVENTION

1. Field of the Invention

The present invention relates to a method for feature vector extraction using a plurality of local linear transformation functions, and a method and apparatus for image recognition employing the extraction method.

2. Description of the Related Art

Face recognition technology identifies faces of one or more persons existing in a still image or moving pictures, by using a given face database. Since face image data vary greatly according to poses and illumination, it is difficult to classify pose data or illumination data of an identical person into one identical class. Therefore, it is necessary to use a classification method with a high degree of accuracy. Examples of widely used linear classification methods include linear discriminant analysis (LDA) and an LDA mixture model, and examples of non-linear classification methods include generalized discriminant analysis (GDA).

In the linear classification methods, LDA is a method of expressing classes of different identifications so that separation of classes can be well achieved. In LDA, a transformation matrix, which maximizes the variance of after-transformation distribution between images belonging to groups of different identifications and minimizes the variance of after-transformation distribution between images, within a group, of an identical person is obtained and applied. However, when data are appropriately separated in terms of 2nd order statistics, the LDA method can efficiently transform the original data space into a low dimensional feature space, but the LDA cannot perform classification of non-linear data having a plurality of modality distributions as shown in FIG. 1A. The LDA is explained in detail in “Introduction to Statistical Pattern Recognition”, 2nd ed., Fukunaga, K. Academic Press, 1990. In the conventional recognition systems employing the same linear classification method as the LDA, many sample groups in which one local frame is formed with at least one or more samples, are registered to enhance recognition performance.

Meanwhile, the LDA mixture model considers a plurality of local frames independently, but cannot encode the relationships among LDA classification results of respective local frames. Accordingly, as in the LDA, the LDA mixture model cannot perform classification of non-linear data having a plurality of modality distributions as shown in FIG. 1B. The LDA mixture model is explained in detail in Hyun-chul Kim, Dai-jin Kim, and Sung-Yang Bang's “Face Recognition Using LDA Mixture Model,” International Conference on Pattern Recognition, Canada, 2002.

In the non-linear classification methods, the GDA maps the original data space into a higher-order feature space by using a kernel function. The GDA method can perform accurate classification of even a non-linear data structure, but it causes excessive feature extraction and matching cost as well as overfitting of learning data. The GDA is explained in detail in G. Baudat and F. Anouar's “Generalized Discriminant Analysis Using a Kernel Approach,” Neural Computation vol. 12, pp. 2385-2404, 2000.

### SUMMARY OF THE INVENTION

According to an aspect of the invention, a method of separating learning images in a predetermined number of local groups and obtaining local linear transformation functions for respective local groups is provided.

According to an aspect of the invention, a method of extracting feature vectors of a registered image or a recognized image by using the local linear transformation functions of the learning images is provided.

According to an aspect of the invention, a method of recognizing an image by using the feature vectors extracted through the local linear transformation functions for the learning images is provided.

According to an aspect of the present invention, there is provided a method of generating a local linear transformation function including: dividing learning images formed with a first predetermined number of classes, into a second predetermined number of local groups; generating a mean vector and a local linear transformation function for each of the divided local groups; and storing the mean vector and local linear transformation function of each local group in a database.

According to another aspect of the present invention, there is provided a method of extracting feature vectors by using local linear transformation functions including: dividing learning images formed with a first predetermined number of classes, into a second predetermined number of local groups, generating a mean vector and a local linear transformation function for each of the divided local groups, and storing in a database; comparing input image vectors with the mean vector of each local group and allocating a local group to the input image; and by vector-projecting the local linear transformation function of the allocated local group on the input image, extracting feature vectors.

According to another aspect of the present invention, there is provided an image recognition method using a local linear transformation function including: dividing learning images formed with a first predetermined number of classes, into a second predetermined number of local groups, generating a mean vector and a local linear transformation function for each of the divided local groups, and storing in a first database; comparing the mean vector of a registered image with the mean vector of each local group stored in the first database, allocating a local group to the registered image, and by vector-projecting the local linear transformation function of the allocated local group on the registered image, extracting feature vectors and storing in a second database; comparing the mean vector of a recognized image with the mean vector of each local group stored in the first database, allocating a local group to the recognized image, and by vector-projecting the local linear transformation function of the allocated local group on the recognized image, extracting feature vectors; and comparing the feature vector of the recognized image with the feature vectors of the registered image stored in the second database.

According to another aspect of the present invention, there is provided an image recognition apparatus using a local linear transformation function including: a feature vector database which stores feature vectors that are extracted by comparing registered image vectors with the mean vector of each local group of learning images, allocating a local group to the registered image, and then vector-projecting the local linear transformation function of the allocated local group on the registered image; a feature vector extraction unit which compares recognized image vectors with the mean vector of each local group of learning images, allocates a local group to the recognized image, and by vector-projecting the local linear transformation function of the allocated local group on the recognized image, extracts feature vectors; and a matching unit which compares the feature vectors of the recognized image with the feature vectors of the registered image stored in the feature vector database.

According to an aspect, the methods can be implemented by a computer readable recording medium having embodied thereon a computer program capable of performing the methods.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A through 1B are diagrams comparing the conventional data classification method and FIG. 1C is a data classification method applied to an embodiment of the present invention;

FIG. 2 is a flowchart explaining a learning process of a learning image according to an embodiment of the present invention;

FIG. 3 is a flowchart showing operation 220 of FIG. 2 in detail;

FIG. 4 is a flowchart showing a process for generating an objective function in FIG. 3;

FIG. 5 is a flowchart showing a process for extracting feature vectors of a registered image according to an embodiment of the present invention;

FIG. 6 is a flowchart showing a process for extracting feature vectors of a recognized image according to an embodiment of the present invention;

FIG. 7 is a block diagram showing the structure of an image recognition apparatus according to an embodiment of the present invention;

FIGS. 8A and 8B are diagrams showing the learning results of learning images according to an embodiment of the present invention;

FIGS. 9A and 9B are diagrams showing two 2-dimensional data sets simulated in order to evaluate the performance of a data classification method applied to an embodiment of the present invention;

FIGS. 10A and 10B are diagrams visually showing transformation vectors by data classification methods applied to principal component analysis (PCA) and an embodiment of present invention, respectively; and

FIG. 11 is a graph comparing face recognition results expressed as a percentage when LDA, GDA, GDA1 and an embodiment of the present invention are applied.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

First, basic principles introduced in the detailed description will now be explained.

Input vectors (X) are formed with a plurality of classes (Cᵢ). Here, x is referred to as a data vector that is an element of a class (Cᵢ). Variable Nc denotes the number of classes. Also, the input vectors (X) are partitioned into a plurality of local groups (Lᵢ) having transformation functions different with respect to each other.

In the initial stage, the learning process will be explained assuming that the number (N_{L}) of local groups is 2, and then the number will be extended to an arbitrary number.

According to this aspect, the input vectors (X) can be expressed by the following equation 1:

$$X = {⋃}_{i = 1}^{{N}_{c}} {C}_{i} = {⋃}_{i = 1}^{{N}_{L}} {L}_{i} \qquad ( 1 )$$

Here, local groups can be defined in a variety of ways. For example, input vectors may be defined with at least two or more local groups, each local group formed with neighboring data vectors, by using K-means clustering or mixture modeling methods.

For convenience of explanation, the data vector (x) is defined as a zero mean vector such that E{xIxεLᵢ}=0 when xεLᵢ. Here, a global mean vector (m) can be defined by the following equation 2:

$$m = \frac{1}{n} {\sum }_{x}^{} x = \frac{1}{n} ( {\sum }_{x ∈ {L}_{1}}^{} x + {\sum }_{x ∈ {L}_{2}}^{} x ) = {m}_{{L}_{1}} + {m}_{{L}_{2}} \qquad ( 2 )$$

Here, n denotes the number of entire input vectors, and m_{L}_{₁} and m_{L}_{di 2} denote mean vectors of data vectors belonging to a first local group (L₁) and a second local group (L₂), respectively.

Meanwhile, a mean vector (mᵢ) of a class (Cᵢ) formed with nᵢ data vectors is defined by the following equation 3:

$${m}_{i} = \frac{1}{{n}_{i}} {\sum }_{x ∈ {C}_{i}}^{} x = \frac{1}{{n}_{i}} ( {\sum }_{x ∈ {C}_{i} ⋂ {L}_{1}}^{} + {\sum }_{x ∈ {C}_{i} ⋂ {L}_{2}}^{} x ) = {m}_{i , {L}_{1}} + {m}_{i , {L}_{2}} \qquad ( 3 )$$

Here, m_{i,L}_{₁} denotes the mean vector of data vectors belonging to a class (Cᵢ) and the first local group (Lᵢ) and m_{i,L}_{₂} denotes the mean vector of data vectors belonging to the class (Cᵢ) and the second local group (L₂).

Next, a between-class scatter matrix (S_{B}) and a within-class scatter matrix (S_{W}) are defined by the following equations 4 and 5, respectively:

$$\begin{matrix}{S}_{B} = {\sum }_{i = 1}^{{N}_{c}} {n}_{i} ( {m}_{i} - m ) {( {m}_{i} - m )}^{T} \\ = {\sum }_{i = 1}^{{N}_{c}} {n}_{i} ( {m}_{i , {L}_{1}} - {m}_{{L}_{1}} ) {( {m}_{i , {L}_{1}} - {m}_{{L}_{1}} )}^{T} + \\ {\sum }_{i = 1}^{{N}_{c}} {n}_{i} ( {m}_{i , {L}_{2}} - {m}_{{L}_{2}} ) {( {m}_{i , {L}_{2}} - {m}_{{L}_{2}} )}^{T} \\ = {\sum {n}_{i}}_{i = 1}^{{N}_{c}} ( {m}_{i , {L}_{1}} - {m}_{{L}_{1}} ) {( {m}_{i , {L}_{1}} - {m}_{{L}_{1}} )}^{T} + \\ {\sum }_{i = 1}^{{N}_{c}} {n}_{i} ( {m}_{i , {L}_{2}} - {m}_{{L}_{2}} ) + {( {m}_{i , {L}_{2}} - {m}_{{L}_{2}} )}^{T} + \\ {\sum }_{i = 1}^{N} {n}_{i} ( {m}_{i , {L}_{1}} - {m}_{{L}_{1}} ) {( {m}_{i , {L}_{2}} - {m}_{{L}_{2}} )}^{T} + \\ {\sum }_{i = 1}^{{N}_{c}} {n}_{i} ( {m}_{i , {L}_{2}} - {m}_{{L}_{2}} ) {( {m}_{i , {L}_{1}} - {m}_{{L}_{1}} )}^{T} \\ = {S}_{B , {L}_{1}} + {S}_{B , {L}_{2}} + {R}_{B} + {R}_{B}^{T}\end{matrix} \qquad ( 4 )$$

Here, S_{B,L}_{₁} and S_{B,L}_{₂} denote the between-class scatter matrices for the first and second local groups (L₁, L₂), respectively, and R_{B} denotes a matrix indicating the correlation matrix of the first and second local groups (L₁, L₂).

$$\begin{matrix}{S}_{w} = {\sum }_{i = 1}^{{N}_{c}} {\sum }_{x ∈ {C}_{i}}^{} ( x - {m}_{i} ) {( x - {m}_{i} )}^{T} \\ = {\sum }_{i = 1}^{{N}_{c}} {\sum }_{x ∈ {C}_{i} ⋂ {L}_{1}}^{} ( x - {m}_{i} ) {( x - {m}_{i} )}^{T} + {\sum }_{i = 1}^{{N}_{c}} {\sum }_{x ∈ {C}_{i} ⋂ {L}_{2}}^{} ( x - {m}_{i} ) {( x - {m}_{i} )}^{T} \\ = {\sum }_{i = 1}^{{N}_{c}} ( {\sum }_{x ∈ {C}_{i} ⋂ {L}_{1}}^{} ( x - {m}_{i , {L}_{1}} ) {( x - {m}_{i , {L}_{1}} )}^{T} + {\sum }_{x ∈ {C}_{i} ⋂ {L}_{2}}^{} {m}_{i , {L}_{1}} {m}_{i , {L}_{1}}^{T} ) + \\ {\sum }_{i = 1}^{{N}_{c}} {\sum }_{x ∈ {C}_{i} ⋂ {L}_{1}}^{} ( - ( x - {m}_{i , {L}_{1}} ) {m}_{i , {L}_{2}}^{T} - {{m}_{i , {L}_{2}} ( x - {m}_{i , {L}_{1}} )}^{T} ) + \\ {\sum }_{i = 1}^{{N}_{c}} ( {\sum }_{x ∈ {C}_{i} ⋂ {L}_{2}}^{} ( x - {m}_{i , {L}_{2}} ) {( x - {m}_{i , {L}_{2}} )}^{T} + {\sum }_{x ∈ {C}_{i} ⋂ {L}_{1}}^{} {m}_{i , {L}_{2}} {m}_{i , {L}_{2}}^{T} ) + \\ {\sum }_{i = 1}^{{N}_{c}} {\sum }_{x ∈ {C}_{i} ⋂ {L}_{2}}^{} ( - ( x - {m}_{i , {L}_{2}} ) {m}_{i , {L}_{1}}^{T} - {{m}_{i , {L}_{1}} ( x - {m}_{i , {L}_{2}} )}^{T} ) \\ = {S}_{W , {L}_{1}} + ( {R}_{W , 12} + {R}_{W , 12}^{T} ) + {S}_{W , {L}_{2}} + ( {R}_{W , 21} + {R}_{W , 21}^{T} ) \end{matrix} \qquad ( 5 )$$

Here, S_{W,L}_{₁} and S_{W,L}_{₂} denote within-class scatter matrices for the first and second local groups (L₁, L₂), respectively. R_{W,12} and R_{W,21} encode the information for aligning the first and second local groups (L₁, L₂). All terms above are defined in order to easily obtain an optimization method to be explained below.

Meanwhile, a local linear transformation function (W₁=[wᵢ₁, . . . , wᵢₙ], i=1, . . . , N_{L}) is defined by the following equation 6 in order to maximize the between-class variance and minimize the within-class variance in a data space transformed by locally linear functions, that is, in data spaces transformed according to the first and second local groups (L₁, L₂) by:
y₁=W₁^{T}x for xεL₁
y₂=W₂^{T}x for xεL₂ (6)

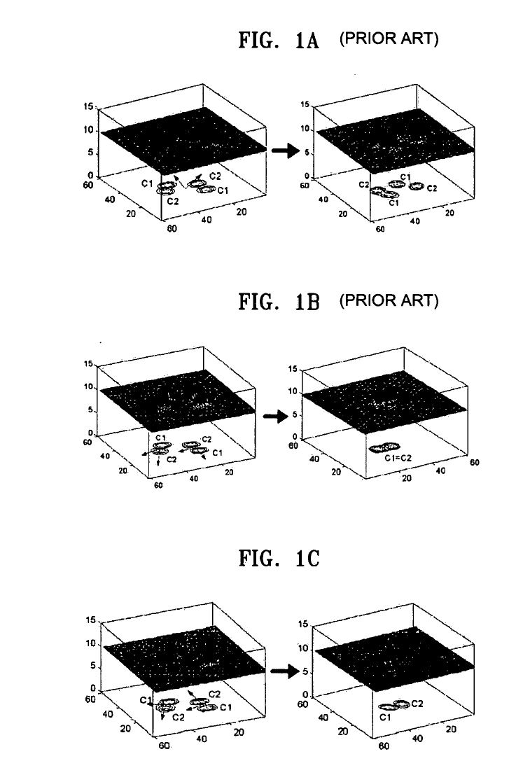

That is, a data vector (x) belonging to the first and second local groups (L₁, L₂) using local linear transformation functions (W₁, W₂) is expressed as a transformation vector, for example, a feature vector (y₁, y₂). The objective function (J) that should be maximized in order to obtain the local linear transformation functions (W₁, W₂) can be expressed by the following equation 7:
J=tr\tilde{S}_{B}−k·tr\tilde{S}_{w} (7)
Here, \tilde{S}_{B} and \tilde{S}_{w} are transformed versions of the between-class matrix and the within-class scatter matrix, respectively, k denotes an adjustable constant, and tr( ) denotes a trace operation. Local linear transformation functions (W₁, W₂) are obtained from a solution that maximizes the objective function (J). If data vectors (x) are classified by using thus obtained local linear transformation functions (W₁, W₂), it is possible to accurately classify data vectors according to an identification, that is, by class, even when data vectors (x) have distributions formed with a plurality of modalities as shown in FIG. 1C.

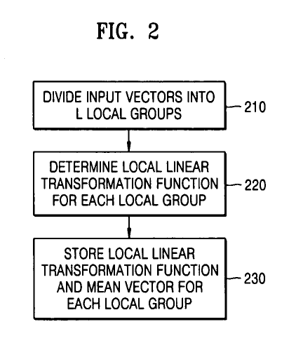

FIG. 2 is a flowchart explaining a learning process of a learning image according to an embodiment of the present invention. Referring to FIG. 2, in operation 210, learning images, that is, input vectors X, formed with a predetermined number of classes, are classified into L local groups. Here, for the input vectors X, K-means clustering or mixture modeling methods can be used.

In operation 220, the mean vector mi and local linear transformation function Wᵢ for each local group Lᵢ are obtained. For this, an objective function (J) to be used is defined, and each vector of the local linear transformation function of each local group is repeatedly updated so that the objective function (J) can be maximized under a predetermined constraint length. This updating process is repeatedly performed until the local linear transformation function formed with the updated vectors converges.

In operation 230, the mean vector and local linear transformation function of each local group determined in operation 220 are stored in a database or other memory.

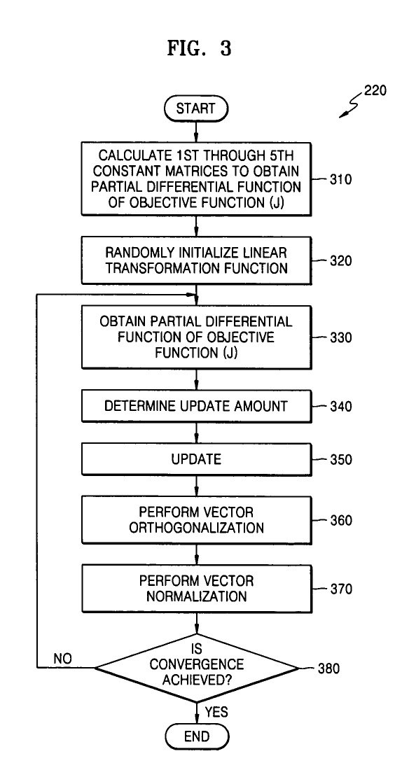

FIG. 3 is a flowchart showing operation 220 of FIG. 2 in detail, and operation 220 is performed for each local group of the learning images. Referring to FIG. 3, in operation 310, first through fifth constant matrices are calculated by using equation 17 to be explained below to obtain a partial differential function of an objective function. In operation 320, the local linear transformation function is initialized with a random value.

In operation 330, a partial differential function of the objective function (J) is obtained by equation 19 to be explained below by using the first through fifth constant matrices obtained in operation 310 and the local linear transformation function.

In operation 340, an update amount of the local linear transformation function of a corresponding local group is determined based on equation 20 to be explained below by using the partial differential function of the objective function. In operation 350, the local linear transformation function for the corresponding local group is updated by adding the update amount determined in operation 340 to the previous local linear transformation function. In operations 360 and 370, vector orthogonalization and vector normalization are sequentially performed for the local linear transformation function updated in operation 350.

In operation 380, operations 330 through 370 are repeatedly performed until convergence of the updated local linear transformation function for which vector normalization is performed in operation 370. Here, examples for determining whether or not the updated linear transformation function converges include determining whether or not the objective function to which the updated local linear transformation function is applied, reaches a saturated state with a predetermined value, or comparing the update amount of the local linear transformation function with a predetermined threshold, and then if the amount is less than the predetermined threshold, determining the convergence. In addition to these methods, the convergence can also be determined by other methods.

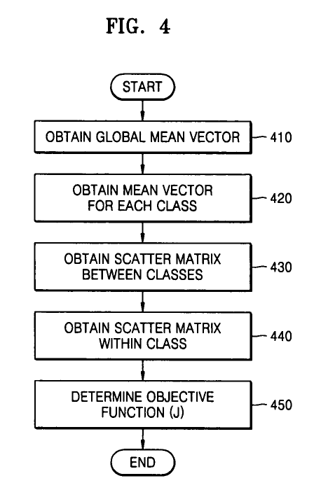

FIG. 4 is a flowchart showing a detailed process for obtaining the objective function (J) in FIG. 3. Referring to FIG. 4, in operations 410 and 420, the global mean vector (\tilde{m}) of all learning images and mean vectors (\tilde{m}ᵢ) for respective class (Cᵢ) of learning images are obtained.

In operations 430 and 440, by using the global mean vector (\tilde{m}) of all learning images and mean vectors (\tilde{m}ᵢ) for respective class (Cᵢ), the between-class scatter matrix (\tilde{S}_{B}) indicating the between-class distribution and the within-class scatter matrix (\tilde{S}_{w}) indicating the within-class distribution are obtained.

In operation 450, by using the between-class scatter matrix (\tilde{S}_{B}) and the within-class scatter matrix (\tilde{S}_{w}) obtained in operations 430 and 440, the objective function (J) is defined.

Each operation shown in FIGS. 3 and 4 will be explained in detail for a case where input vectors are defined as 2 local groups and for a case where input vectors are defined as L local groups.

First, in the case where input vectors are defined as 2 local groups, one basis vector (w₁₁, w₂₁) in the local linear transformation function (W₁, W₂) for respective local groups (L₁, L₂) will now be explained.

In order to define the objective function (J), first, the global mean vector (\tilde{m}) of all learning images and mean vectors (\tilde{m}ᵢ) for each respective class (Cᵢ) are defined by the following equations 8 and 9, respectively, in operations 410 and 420:
\tilde{m}=w₁₁^{t}m_{L}_{₁}+w₂₁^{t}m_{L}_{₂} (8)
\tilde{m}ᵢ=w₁₁^{t}m_{i,L}_{₁}+w₂₁^{t}m_{i,L}_{₂} (9)

Next, the between-class scatter matrix (\tilde{S}_{B}) indicating the between-class distribution is obtained the following equation 10 in operation 430:

$$\begin{matrix}{\tilde{S}}_{B} = {\sum }_{i = 1}^{{N}_{c}} {n}_{i} {w}_{11}^{t} ( {m}_{i , {L}_{1}} - {m}_{{L}_{1}} ) {( {m}_{i , {L}_{1}} - {m}_{{L}_{1}} )}^{T} {w}_{11} + \\ {\sum }_{i = 1}^{{N}_{c}} {n}_{i} {w}_{21}^{t} ( {m}_{i , {L}_{2}} - {m}_{{L}_{2}} ) {( {m}_{i , {L}_{2}} - {m}_{{L}_{2}} )}^{T} {w}_{21} + \\ {\sum }_{i = 1}^{{N}_{c}} {n}_{i} 2 {w}_{11}^{t} ( {m}_{i , {L}_{1}} - {m}_{{L}_{1}} ) {( {m}_{i , {L}_{2}} - {m}_{{L}_{2}} )}^{T} {w}_{21} \\ = {w}_{11}^{t} {S}_{B , {L}_{1}} {w}_{11} + {w}_{21}^{t} {S}_{B , {L}_{2}} {w}_{21} + 2 {w}_{11}^{t} {R}_{B} {w}_{21}\end{matrix} \qquad ( 10 )$$

Next, the within-class scatter matrix (\tilde{S}_{w}) indicating the within-class distribution is obtained as the following equation 11 in operation 440:
\tilde{S}_{w}=w₁₁^{t}S_{W,L}_{₁}w₁₁+w₂₁^{t}S_{W,L}_{₂}w₂₁+2w₁₁^{t}R_{W,12}w₂₁+2w₂₁^{t}R_{W,21}w₁₁ (11)

By using the between-class scatter matrix (\tilde{S}_{B}) and the within-class scatter matrix (\tilde{S}_{w}) obtained in operations 430 and 440, the objective function (J) defined by the equation 7 can be obtained in operation 450.

Next, vectors w₁₁ and w₂₁, which maximize the objective function (J) under a constraint length of unit norm vectors, are obtained in operations 320 through 350.

Optimization under a constraint length can be performed by a projection method for a constraint length set, which is disclosed in a book written by Aapo Hyvarinen, Juha Karhunen, and Erkki Oja, “Independent Component Analysis”, John Wiley & Sons, Inc. 2001. In order to obtain the solution of equation 7, that is, the local linear transformation function, iterative optimization methods are used, in this aspect a gradient-based learning method is used, though other iterative optimization methods are also suitable. The objective function (J) that is a 2nd-order convex function to which the local linear transformation function, obtained according to the gradient-based learning method, is applied will have a global maximum value.

That is, in the local linear transformation functions (W₁, W₂) for respective local groups (L₁, L₂) that maximize the objective function (J) defined by the following equation 12, basis vectors w₁₁ and w₂₁, are learned and updated through the process for obtaining a partial differential function of the following equation 13, the process for determining the update amount of the equation 14, and the process for vector normalization of the equation 15:
Max J=J=\tilde{S}_{B}−k\tilde{S}_{w}, for ∥w₁₁∥=1, ∥w₂₁∥=1 (12)

$$\begin{matrix}\begin{matrix}\frac{\partial J}{\partial {w}_{11}} = ( 2 {S}_{B , {L}_{1}} - 2 k {S}_{W , {L}_{1}} ) {w}_{11} + \\ ( 2 {R}_{B} - 2 k {R}_{W , 12} - 2 k {R}_{W , 21}^{T} ) {w}_{21} \\ \frac{\partial J}{\partial {w}_{21}} = ( 2 {R}_{B}^{T} - 2 k {R}_{W , 12}^{T} - 2 k {R}_{W , 21} ) {w}_{11} + \\ ( 2 {S}_{B , {L}_{2}} - 2 k {S}_{W , {L}_{2}} ) {w}_{21}\end{matrix} & ( 13 ) \\ Δ {w}_{11} ← η \frac{\partial J}{\partial {w}_{11}} , Δ {w}_{21} ← η \frac{\partial J}{\partial {w}_{21}} & ( 14 )\end{matrix}$$

Here, η denotes an appropriate learning coefficient.
w₁₁←w₁₁/∥w₁₁∥, w₂₁←w₂₁/∥w₂₁∥ (15)

Meanwhile, by applying operations 410 through 450 to the remaining vectors (w₁₂˜w₁ₚ, w₂₂˜w₂ₚ) in the local linear transformation functions (W₁, W₂) for respective local groups (L₁, L₂), the objective function (J) corresponding to each vector can also be obtained.

In order to efficiently obtain the remaining vectors (w₁₂˜w₁ₚ, w₂₂˜w₂ₚ), for example, deflationary orthogonalization is applied. The deflationary orthogonalization is described in detail in the book written by Aapo Hyvarinen, Juha Karhunen, and Erkki Oja, “Independent Component Analysis”, John Wiley & Sons, Inc. 2001.

Also, the single basis vector update algorithm formed with the equations 8 through 11 is repeatedly applied to the remaining vectors (w₁₂, . . . , w₁ₚ and w₂₂, . . . , w₂ₚ). In order to prevent different vectors from converging on an identical maximum value after each iteration, vector orthogonalization is performed. By performing this orthogonalization, it can be guaranteed that the data classification method according to aspects of the present invention is determined by an orthogonal basis vector belonging to a local group.

That is, in the local linear transformation function (W₁) for the first local group (L₁) which maximizes the objective function (J), basis vectors (w₁ₚ) are learned and updated by the process for determining the update amount of the following equation 16, the process for vector orthogonalization of the equation 17, and the process for vector normalization of the equation 18:

$$\begin{matrix}Δ {w}_{1 p} ← η \frac{\partial J}{\partial {w}_{1 p}} & ( 16 ) \\ {w}_{1 p} ← {w}_{1 p} {\sum }_{j = 1}^{p - 1} ( {w}_{1 p}^{T} {w}_{1 j} ) {w}_{1 j} & ( 17 )\end{matrix}$$

w₁ₚ←w₁ₚ/∥w₁ₚ∥ (18)

Likewise, in the local linear transformation function (W₂) for the second local group (L₂), the identical method is applied to the basis vectors (w₂p).

Meanwhile, when input vectors are defined by L local groups and xεLᵢ, the simplified expression for each local group is obtained as yᵢ=Wᵢ^{t}x.

At this time, in operation 310 for obtaining the objective function (Max J) to obtain the local linear transformation function (Wᵢ, i is an integer between 1 and L) for each local group (Lᵢ, i is an integer between 1 and L), the transformed global mean vector (\tilde{m}) and the transformed mean vectors (\tilde{m}ᵢ) for each respective class (Cᵢ) can be expressed by the following equations 19 and 20, respectively, in operations 410 and 420:

$$\begin{matrix}\tilde{m} = {\sum }_{i = 1}^{L} {W}_{i}^{t} {m}_{{L}_{1}} & ( 19 ) \\ {\tilde{m}}_{i} = {\sum }_{j = 1}^{L} {W}_{j}^{t} {m}_{i , {L}_{1}} & ( 20 )\end{matrix}$$

Next, the transformed between-class scatter matrix and within-class scatter matrix (\tilde{S}_{B}, \tilde{S}_{w}) are obtained and these can be defined by the following equations 21 in operations 430 and 440:

$${\tilde{S}}_{B} = {\sum }_{i = 1}^{L} {W}_{i}^{t} {S}_{B , {L}_{i}} {W}_{i} + {\sum }_{i = 1}^{L - 1} {\sum }_{j = i + 1}^{L} 2 {W}_{i}^{t} {R}_{B , ij} {W}_{j} \\ {\tilde{S}}_{W} = {\sum }_{i = 1}^{L} {W}_{i}^{t} {S}_{W , {L}_{i}} {W}_{i} + {\sum }_{l = 1}^{L} {\sum }_{j = 1 , j \neq i}^{L} 2 {W}_{i}^{t} {R}_{W , ij} {W}_{j} + {\sum }_{i = 1}^{L} {\sum }_{j = 1 , j \neq i}^{L} {\sum }_{k = 1 , k \neq i , j}^{L} {W}_{j}^{t} {T}_{W , ijk} {W}_{k} \qquad ( 21 )$$

Here, S_{B,L}_{ⱼ}, R_{B,L}_{ⱼₖ}, R_{W,jk}, and T_{W,jkl} denote the first through fifth constant matrices and are defined by the following equations 22:

$${S}_{B , {L}_{j}} = {\sum }_{i = 1}^{c} {n}_{i} ( {m}_{i , {L}_{j}} - {m}_{{L}_{j}} ) {( {m}_{i , {L}_{j}} - {m}_{{L}_{j}} )}^{T} \\ {R}_{B , {L}_{ik}} = {\sum }_{i = 1}^{c} {n}_{i} ( {m}_{i , {L}_{i}} - {m}_{{L}_{j}} ) {( {m}_{i , {L}_{k}} - {m}_{{L}_{k}} )}^{T} \\ {S}_{W , {L}_{j}} = {\sum }_{i = 1}^{c} ( {\sum }_{x ∈ {C}_{i} , {L}_{j}}^{} ( x - {m}_{i , {L}_{j}} ) {( x - {m}_{i , {L}_{j}} )}^{T} + ( {n}_{i} - {n}_{i , {L}_{j}} ) {m}_{i , {L}_{j}} {{m}_{i , {L}_{j}}}^{T} ) \\ {R}_{W , jk} = {\sum }_{i = 1}^{c} ( {\sum }_{x ∈ {C}_{l} , {L}_{j}}^{} - ( x - {m}_{i , {L}_{j}} ) {{m}_{i , {L}_{k}}}^{T} ) \\ {T}_{W , jkl} = {\sum }_{i = 1}^{c} ( {\sum }_{x ∈ {C}_{i} , {L}_{j}}^{} {m}_{i , {L}_{k}} {{m}_{i , {L}_{i}}}^{T} ) . \qquad ( 22 )$$

By using the transformed between-class scatter matrix (\tilde{S}_{B}) and within-class scatter matrix (\tilde{S}_{w}) obtained in operations 430 and 440, the objective function (J) defined as the following equation 23 can be obtained in operation 450:
Max J=tr\tilde{S}_{B}−k·tr\tilde{S}_{w}, for ∥wᵢₗ∥=1 (23)

In the local linear transformation function of each local group, the gradient (J/wᵢₚ) of the objective function (Max J) for the basis vector (wᵢₗ) and the basis vector (wᵢₚ) that is orthonormal to other basis vectors in an i-th local group can be obtained by the following equations 24 through 27, respectively, in operations 330 through 380:

$$\begin{matrix}\frac{\partial J}{\partial {w}_{il}} = ( 2 {S}_{B , {L}_{i}} - 2 {kS}_{W , {L}_{i}} ) {w}_{il} + {\sum }_{j = 1 , j \neq i}^{L} 2 {R}_{B , ij} {w}_{jl} - 2 k {\sum }_{j = 1 , j \neq i}^{L} ( {R}_{W , ij} + {R}_{W , ji}^{T} ) {w}_{jl} - k {\sum }_{j = 1 , j \neq i}^{L} {\sum }_{k = 1 , k \neq i , j}^{L} ( {T}_{W , jik} + {T}_{W , jki}^{T} ) {w}_{kl} & ( 24 ) \\ Δ {w}_{ip} ← η \frac{\partial J}{\partial {w}_{ip}} & ( 25 ) \\ {w}_{ip} ← {w}_{ip} - {\sum }_{j = 1}^{p - 1} ( {w}_{ip}^{T} {w}_{ij} ) {w}_{ij} & ( 26 )\end{matrix}$$

wᵢₚ←wᵢₚ/∥wᵢₚ∥ (27)

Meanwhile, the solution to the equation 12 can also be obtained by using the Lagrangian function (L) defined by the following equation 28. The equation 28 is applied only when input vectors are divided into two local groups:
L=tr└\tilde{S}_{B}−k\tilde{S}₂Λ₁(W₁^{T}W₁−I)−Λ₂(W₂^{T}W_{w}−I)┘ (28)
Here, Λᵢ denotes a diagonal matrix formed with eigen values expressed by the following equation 29, and I denotes the identity matrix.

$${Λ}_{i} = [ \begin{matrix}{λ}_{i1} & & O \\ & ⋰ & \\ O & & {λ}_{lp}\end{matrix} ] \qquad ( 29 )$$

The gradient of the Lagrangian function for the basis vector can be expressed by the following equations 30:

$$\frac{\partial L}{\partial {w}_{1 l}} = ( 2 {S}_{B , {L}_{i}} - 2 {kS}_{W , {L}_{i}} - 2 {λ}_{1} I ) {w}_{1 l} + ( 2 {R}_{B} - 2 {kR}_{W} - 2 {kT}_{W}^{T} ) {w}_{2 l} = 0 \\ \frac{\partial L}{\partial {w}_{2 l}} = ( 2 {R}_{B}^{T} - 2 {kR}_{W}^{T} - 2 {kT}_{W} ) {w}_{1 l} + ( 2 {S}_{B , {L}_{2}} - 2 {kS}_{W , {L}_{2}} - 2 {λ}_{2} I ) {w}_{2 l} = 0 \qquad ( 30 )$$

The data classification method applied to embodiments of the present invention can converge on a global maximum value due to the objective function that is the 2nd-order convex function for the basis vectors (w₁ₗ, w₂ₗ) existing in the local linear transformation function for each local group.

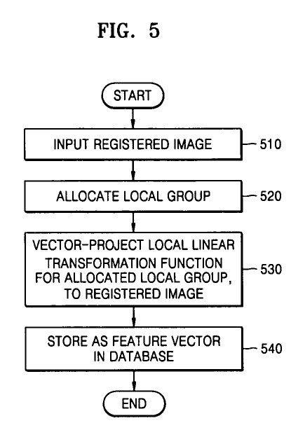

FIG. 5 is a flowchart showing a process for extracting feature vectors of a registered image according to an embodiment of the present invention. Referring to FIG. 5, in operation 510, a registered image is input. In operation 520, vectors of the registered image are compared with the mean vector of each local group of the learning images obtained by the process shown in FIG. 2, and a local group to which the nearest mean vector belongs is allocated as the local group of the registered image.

In operation 530, with respect to the local group allocated in operation 520, by vector-projecting the local linear transformation function obtained by the process shown in FIG. 3, on the registered image, feature vectors are extracted. The feature vectors are stored in a database or other memory in operation 540.

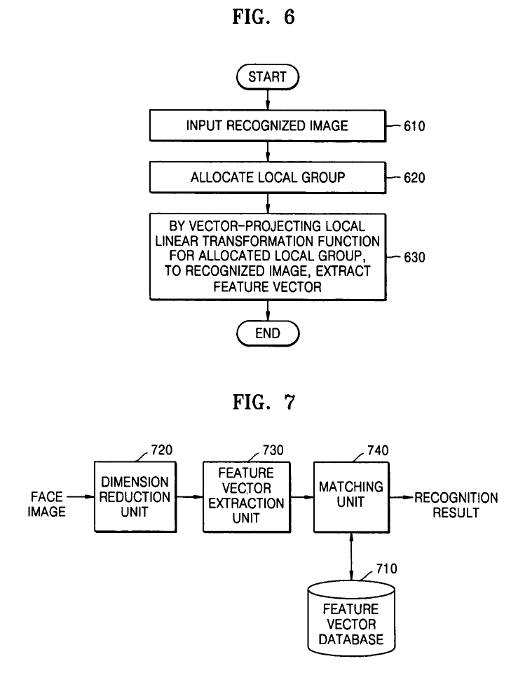

FIG. 6 is a flowchart showing a process for extracting feature vectors of a recognized image according to an embodiment of the present invention.

In operation 610, a recognized image is input. In operation 620, the mean vector of the recognized image is compared with the mean vector of each local group of the learning images obtained by the process shown in FIG. 2, and a local group to which the nearest mean vector belongs is allocated as the local group of the recognized image.

In operation 630, with respect to the local group allocated in operation 620, feature vectors are extracted by vector-projecting the local linear transformation function obtained by the process shown in FIG. 3, on the recognized image.

FIG. 7 is a block diagram showing the structure of an image recognition apparatus according to an embodiment of the present invention, and the apparatus comprises a feature vector database 710, a dimension reduction unit 720, a feature vector extraction unit 730, and a matching unit 740.

Referring to FIG. 7, the feature vector database 710 stores feature vectors that are extracted by comparing registered image vectors with the mean vector of each local group of the learning images, allocating a local group to the registered image, and then vector-projecting the local linear transformation function of the allocated local group on the registered image. In this aspect, the feature vectors of the registered image are extracted according to the procedure shown in FIG. 5 by using the mean vector for each local group of the learning images and the local linear transformation functions according to the method shown in FIG. 2.

The dimension reduction unit 720 can greatly reduce the dimensions of a recognized image by performing a predetermined transformation, such as a Principal Component Analysis (PCA) transformation, for the recognized image vectors in order to reduce the dimension of the input recognized image. It is understood that the dimension reduction unit 720 may be omitted in some embodiments.

The feature vector extraction unit 730 compares the recognized image vectors, whose dimension is reduced in the dimension reduction unit 720, with the mean vector of each local group of learning images, allocates a local group to the recognized image, and by vector-projecting the local linear transformation function of the allocated local group on the recognized image, extracts feature vectors.

At this time, by using the mean vector for each local group of the learning images and the local linear transformation functions according to the method shown in FIG. 2, the feature vectors of the recognized image are extracted according to the procedure shown in FIG. 6.

The matching unit 740 compares the feature vectors of the recognized image extracted in the feature vector extraction unit 730, with the feature vectors of the registered images stored in the feature vector database 710, and according to the matching result, outputs a recognition result on the recognized image.

FIGS. 8A and 8B are diagrams showing the learning results of the data classification method applied to an embodiment of the present invention, with an example case of FIG. 1C when the number of local groups is 2.

FIG. 8A shows the value of the objective function (here, k=0.1) as the orientation function of w₁₁ and w₁₂. FIG. 8B shows convergence graphs with k=0.1, k=1, and k=10.

Referring to FIG. 8A, it can be seen that the objective function has two local maximum values corresponding to two sets of basis vectors in opposite directions. Two local maximum values generate the identical objective function value having a global maximum value. Referring to FIG. 8B, it can be seen that the data classification method according to an embodiment of the present invention converges gradually on a global maximum value after a predetermined number of iterations irrespective of constant k.

Next, in order to evaluate the performance of the data classification method applied to embodiments of the present invention, two simulated 2-dimensional data sets were designed and experimented.

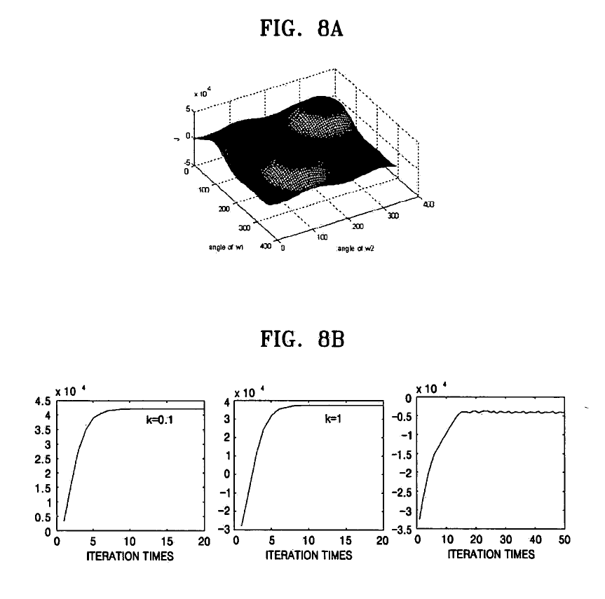

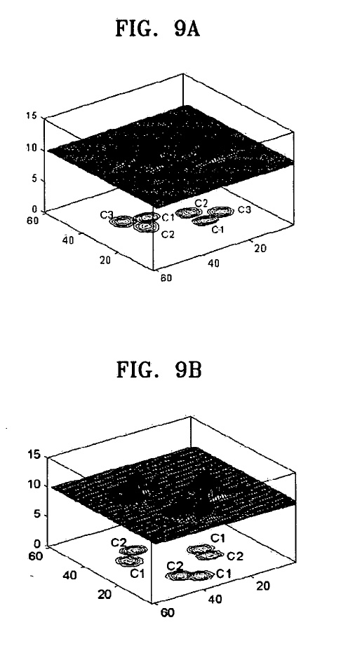

Set 1 has 3 classes having 2 distinct modalities in the data distributions as shown in FIG. 9A, and set 2 has 2 classes having 3 distinct peaks in the data distributions as shown in FIG. 9B. As methods for measuring similarity on nearest-neighbor (N-N) classification, Euclidean distance (Euclidean), normalized cross-correlation (Cross-corr.), and Mahalobis (Mahal) were used. At this time, it was assumed that the number of local groups is already known. Though there are a variety of methods to determine a local group, the K-means clustering algorithm was used in this aspect. Meanwhile, as another element to evaluate the performances of four methods, the relative complexity in feature vector extraction (F.E.) is considered.

The number of classification errors of the classification results by using the conventional Linear Discriminant Analysis (LDA), LDA mixture model, and Generalized Discriminant Analysis (GDA), and an embodiment of the present invention, respectively, are as shown in the following table 1:

TABLE 1

| | | Euclidean | Cross-corr. | Mahal | Relative F.E. |
|---|---|---|---|---|---|
| | | Error | Error | Error | complexity |
| Set 1 (400 | Present | 7.6 ± 3.5 | 8 ± 3.6 | 7.3 ± 3.7 | 1 + alpha |
| samples/ | invention | | | | |
| class) | LDA | 266.6 ± 115.4 | 266.6 ± 115.4 | 81.3 ± 61.6 | 1 |
| | LDA mixture | 254 ± 27.8 | 255 ± 23.5 | 169.6 ± 45.5 | 1 + alpha |
| | GDA | 4.3 ± 1.1 | 4.3 ± 1.1 | 4.4 ± 0.5 | 270 |
| Set 2 (600 | Present | 8 ± 1.4 | 8 ± 1.4 | 7 ± 2.8 | 1 + alpha |
| samples/ | invention | | | | |
| class) | LDA | 308.5 ± 129.4 | 308.5 ± 129.4 | 207.5 ± 272.2 | 1 |
| | LDA mixture | 205 ± 1.4 | 205 ± 1.4 | 206 ± 7 | 1 + alpha |
| | GDA | 4 ± 1.4 | 4 ± 1.4 | 4 ± 0 | 278 |

Here, ‘alpha’ usually has a value less than 1, and indicates a calculation cost to determine which local group a new pattern belongs to.

Referring to table 1, in the 3-type classification errors, the example embodiment of the present invention shows a superior performance compared to those of the LDA and the LDA mixture models in terms of the number of classification errors. Compared to the GDA, the present invention shows a similar performance but is far superior in terms of calculation efficiency during feature vector extraction (F.E.), because the relative F.E. complexity of the example embodiment of the present invention is just one compared to the hundreds of that of the GDA.

Next, an evaluation of the performance of a face recognition system employing the data classification method applied to an embodiment of the present invention will now be explained. Face images that vary greatly according to poses have been known to have multiple modalities. Here, XM2VTS data sets having the pose label of a face image is used and the pose label is used to determine a local group. The face database is formed with 295×2 face images normalized to 23×28 pixel resolution with a fixed eye position. Each face image has a frontal view image and a right-rotated view image. The frontal view image was registered and the right-rotated view image is considered as a query. For simplicity of the learning, 50 eigen features were used and it can be seen that the 50 eigen features are sufficient to describe the images according to the eigen value plot of the data set.

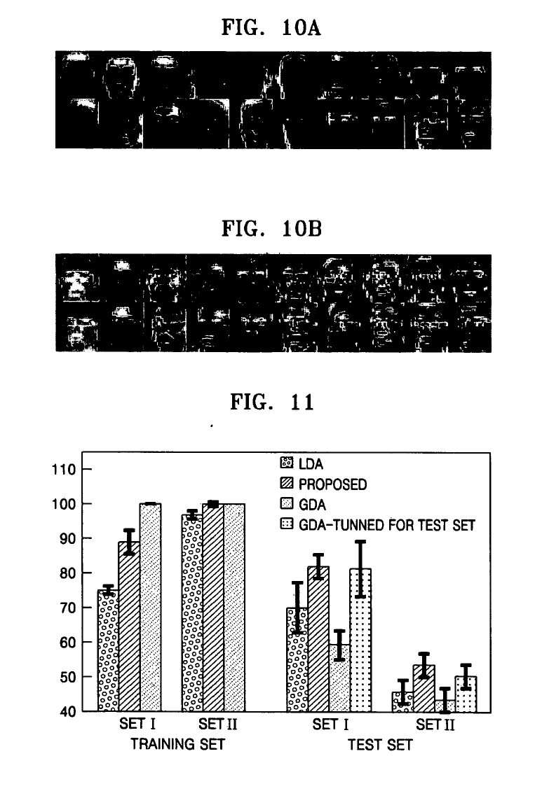

FIGS. 10A and 10B are diagrams visually showing transformation vectors by data classification methods applied to principal component analysis (PCA) and an embodiment of the present invention, respectively. The first row shows transformation vectors of the frontal images and the second row shows transformation vectors of the right-rotated images.

Referring to FIGS. 10A and 10B, it can be seen that it is difficult to describe the relationship between the transformation functions of the frontal images and the right-rotated images except with the first eigen face. That is, the first eigen face shows the relations of the two transformation functions when rotation, scaling and translation are performed.

For two cases having different numbers of training images and test images, 3 training and test sets are randomly designed. The first case has face images of 245 persons (245×2) for training, and face images of 50 persons (50×2) for testing. The second case has face images of 100 persons (100×2) for training and face images of 195 persons (195×2) for testing. In the present invention, the value k is selected with a value having the best performance empirically or experimentally for the training sets. For the GDA, while an RBF kernel is used, the standard deviation of the kernel is adjusted.

FIG. 11 is a graph comparing face recognition results expressed as a recognition percentage when the LDA, GDA, GDA1 and the present invention are applied. It can be seen that the GDA is highly overfitted for the training sets and the proposed method according to embodiments of the present invention is far superior for the testing sets. Here, the GDA1 refers to the best face recognition results obtained by adjusting the kernel parameter for the test sets (i.e., GDA-Tuned for Test Set).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

According to aspects of the present invention as described above, the data structure which has many modality distributions because of a great degree of variance with respect to poses or illumination, such as that of face image data, is divided into a predetermined number of local groups, and a local linear transformation function for each local group is obtained through learning. Then, by using the local linear transformation functions, feature vectors of registered images and recognized images are extracted such that the images can be recognized with higher accuracy.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of generating a local linear transformation function, comprising:
dividing learning images formed with a first predetermined number of classes, into a second predetermined number of local groups;
generating a mean vector and a set of local linear transformation functions for each of the divided local groups; and
storing the mean vector and local linear transformation functions of each local group.

2. The method of claim 1, wherein the dividing the learning images into the second predetermined number of local groups comprises:
initializing the local linear transformation function for the corresponding local group;
obtaining a partial differential function of an objective function;
updating the local linear transformation function of the corresponding local group by using the partial differential function of the objective function;
performing the obtaining the partial differential function and the updating until the iterative update of the local linear transformation function converges; and
for the second predetermined number of local groups, repeatedly performing from the initialization of the local linear transformation function.

3. The method of claim 2, wherein the obtaining the partial differential function comprises:
calculating first through fifth constant matrices to obtain the partial differential function of the objective function based on the local linear transformation function and the mean vector; and
obtaining the partial differential function of the objective function by using the first through fifth constant matrices and the local linear transformation function.

4. The method of claim 2, wherein the partial differential function of the objective function is defined by the following equation:
$$\frac{\partial L}{\partial {w}_{1 l}} = ( 2 {S}_{B , {L}_{i}} - 2 {kS}_{W , {L}_{i}} ) {w}_{il} + {\sum }_{j = 1 , j \neq i}^{L} 2 {R}_{B , ij} {w}_{jl} - 2 k {\sum }_{j = 1 , j \neq i}^{L} ( {R}_{W , ij} + {R}_{W , ji}^{T} ) {w}_{jl} - k {\sum }_{j = 1 , j \neq i}^{L} {\sum }_{k = 1 , k \neq i}^{L} ( {T}_{W , jik} + {T}_{W , jki}^{T} ) {w}_{kl}$$
where J denotes an objective function, S_{B,L}_{ⱼ}, R_{B,L}_{ⱼₖ}, S_{W,L}_{ⱼ}, R_{W,jk}, and T_{W,jkl} denote a first through fifth constant matrices, respectively, wᵢₗ, wⱼₗ, and wₖₗ denote vectors of the local linear transformation functions for i-th through k-th local groups, respectively, and k denotes an adjustable constant.

5. The method of claim 4, wherein the first through fifth constant matrices (S_{B,L}_{ⱼ}, R_{B,L}_{ⱼₖ}, S_{W,L}_{ⱼ}, R_{W,jk}, and T_{W,jkl}) are defined by the following equations:
$${S}_{B , {L}_{j}} = {\sum }_{i = 1}^{c} {n}_{i} ( {m}_{i , {L}_{j}} - {m}_{{L}_{j}} ) {( {m}_{i , {L}_{j}} - {m}_{{L}_{j}} )}^{T}$$
$${R}_{B , {L}_{jk}} = {\sum }_{i = 1}^{c} {n}_{i} ( {m}_{i , {L}_{j}} - {m}_{{L}_{j}} ) {( {m}_{i , {L}_{k}} - {m}_{{L}_{k}} )}^{T}$$
$${S}_{W , {L}_{j}} = {\sum }_{i = 1}^{c} ( {\sum }_{x ∈ {C}_{i} , {L}_{j}}^{c} ( x - {m}_{i , {L}_{j}} ) {( x - {m}_{i , {L}_{j}} )}^{T} + ( {n}_{i} - {n}_{i , {L}_{j}} ) {m}_{i , {L}_{j}} {m}_{i , {L}_{j}}^{T} )$$
$${R}_{W , jk} = {\sum }_{i = 1}^{c} ( {\sum }_{x ∈ {C}_{i} , {L}_{j}} - ( x - {m}_{i , {L}_{j}} ) {m}_{i , {L}_{k}}^{T} )$$
$${T}_{W , jkl} = {\sum }_{i = 1}^{c} ( {\sum }_{x ∈ {C}_{i} , {L}_{j}} {m}_{i , {L}_{k}} {m}_{i , {L}_{l}}^{T} ) .$$
where x denotes a vector corresponding to each learning image, nᵢ denotes the number of learning images belonging to class (Cᵢ), m_{L}_{ₗ} and m_{L}_{ₖ} denote mean vectors of learning images belonging to a j-th local group (Lⱼ) and a k-th local group (Lₖ), respectively, m_{i,L}_{ⱼ} denotes the mean vector of a learning image belonging to class (Cᵢ) and the j-th local group (Lⱼ), and m_{i,L}_{ₖ} denotes the mean vector of a learning image belonging to class (Cᵢ) and the k-th local group (Lₖ).

6. The method of claim 2, wherein the objective function is defined by the following equations:
Max J=tr\tilde{S}_{B}−k·tr\tilde{S}_{w}, for ∥wᵢₗ∥=1
$${\tilde{S}}_{B} = {\sum }_{i = l}^{L} {W}_{i}^{t} {S}_{B , {L}_{i}} {W}_{i} + {\sum }_{i = l}^{L - 1} {\sum }_{j = i + 1}^{L} 2 {W}_{i}^{t} {R}_{B , ij} {W}_{j}$$
$${\tilde{S}}_{W} = {\sum }_{i = l}^{L} {W}_{i}^{t} {S}_{W , {L}_{i}} {W}_{i} + {\sum }_{i = l}^{L - 1} {\sum }_{j = 1 , j \neq i}^{L} 2 {W}_{i}^{t} {R}_{W , ij} {W}_{j} + {\sum }_{i = l}^{L} {\sum }_{j = 1 , j \neq i}^{L} {\sum }_{k = 1 , k \neq i , j}^{L} {W}_{j}^{i} {T}_{W , ijk} {W}_{k}$$
where, J denotes a objective function, tr denotes a trace operation, \tilde{S}_{B} and \tilde{S}_{w} denote a between-class scatter matrix and a within-class scatter matrix, respectively, wᵢₗ denotes the vector of the local linear transformation function for an i-th local group, S_{B,L}_{ⱼ}, R_{B,L}_{ⱼₖ}, S_{W,L}_{ⱼ}, R_{W,jk}, and T_{W,jkl} denote first through fifth constant matrices, respectively, and Wᵢ, Wⱼ, and Wₖ denote the sets of local linear transformation functions for the i-th through k-th local groups, respectively.

7. The method of claim 2, wherein the updating the local linear transformation function comprises:
determining an update amount of the local linear transformation function for the corresponding local group by using the partial differential function of the objective function;
updating the local linear transformation function for the corresponding local group by adding the determined update amount to the previous local linear transformation function; and
sequentially performing vector orthogonalization and vector normalization for the updated local linear transformation function.

8. The method of claim 7, wherein the update amount of the local linear transformation function is obtained by multiplying the partial differential function of the objective function by a predetermined learning coefficient.

9. The method of claim 7, wherein the sequentially performing vector orthogonalization and vector normalization is performed by the following equations:
$${w}_{ip} ← {w}_{ip} - {\sum }_{j = 1}^{p - 1} ( {w}_{ip}^{T} {w}_{ij} ) {w}_{ij}$$
wᵢₚ←wᵢₚ/∥wᵢₚ∥
where wᵢₚ, and wᵢⱼ denote the vector of the local linear transformation function for an i-th local group, and ∥wᵢₚ∥ denotes the unit norm vector of wᵢₚ.

10. The method of claim 2, wherein the performing the obtaining the partial differential function and the updating until the update of the local linear transformation function converges, comprises determining whether the local linear transformation function converges according to whether the objective function reaches a saturated state with a predetermined value.

11. The method of claim 2, wherein the performing the obtaining the partial differential function and the updating until the update of the local linear transformation function converges, comprises comparing the update amount of the local linear transformation function with a predetermined threshold and according to the comparison result, determining whether the local linear transformation function converges.

12. A method of extracting feature vectors by using local linear transformation functions, comprising:
dividing learning images formed with a first predetermined number of classes, into a second predetermined number of local groups;
generating a mean vector and a local linear transformation function for each of the divided local groups;
storing the mean vector and local linear transformation functions of each local group;
comparing input image vectors of an input image with the mean vector of each local group and allocating one of the local groups to the input image; and
extracting feature vectors by vector-projecting the local linear transformation function of the allocated local group on the input image.

13. The method of claim 12, wherein the dividing the learning images into the second predetermined number of local groups, comprises updating the local linear transformation function of a corresponding local group by using a partial differential function of an objective function, until the local linear transformation function converges.

14. The method of claim 13, wherein the updating the local linear transformation function comprises:
initializing the local linear transformation function for the corresponding local group;
calculating first through fifth constant matrices to obtain the partial differential function of the objective function;
obtaining the partial differential function of the objective function by using the first through fifth constant matrices and the local linear transformation function;
updating the local linear transformation function of the corresponding local group by using the partial different function of the objective function; and
performing the obtaining the partial differential function and the updating until the update of the local linear transformation functions converges.

15. The method of claim 14, wherein the partial differential function of the objective function is defined by the following equation:
$$\frac{\partial J}{\partial {w}_{il}} = ( 2 {S}_{B , {L}_{i}} - 2 {kS}_{W , {L}_{i}} ) {w}_{il} + {\sum }_{j = 1 , j \neq i}^{L} 2 {R}_{B , ij} {w}_{jl} - 2 k {\sum }_{j = 1 , j \neq i}^{L} ( {R}_{W , ij} + {R}_{W , ji}^{T} ) {w}_{jl} - k {\sum }_{j = 1 , j \neq i}^{L} {\sum }_{k = 1 , k \neq i , j}^{L} ( {T}_{W , jik} + {T}_{W , jki}^{T} ) {w}_{kl}$$
where J denotes an objective function, S_{B,L}_{ⱼ}, R_{B,L}_{ⱼₖ}, S_{W,L}_{ⱼ}, R_{W,jk}, and T_{W,jkl} denote first through fifth constant matrices, respectively, wᵢₗ, wⱼₗ, and wₖₗ denote vectors of the local linear transformation functions for i-th through k-th local groups, respectively, and k denotes an adjustable constant.

16. The method of claim 15, wherein the first through fifth constant matrices (S_{B,L}_{ⱼ}, R_{B,L}_{ⱼₖ}, S_{W,L}_{ⱼ}, R_{W,jk}, and T_{W,jkl}) are defined by the following equations:
$${S}_{B , {L}_{j}} = {\sum }_{i = 1}^{c} {n}_{i} ( {m}_{i , {L}_{j}} - {m}_{{L}_{j}} ) {( {m}_{i , {L}_{j}} - {m}_{{L}_{j}} )}^{T}$$
$${R}_{B , {L}_{jk}} = {\sum }_{i = 1}^{c} {n}_{i} ( {m}_{i , {L}_{j}} - {m}_{{L}_{j}} ) {( {m}_{i , {L}_{k}} - {m}_{{L}_{k}} )}^{T}$$
$${S}_{W , {L}_{j}} = {\sum }_{i = 1}^{c} ( {\sum }_{x ∈ {C}_{i} , {L}_{j}}^{c} ( x - {m}_{i , {L}_{j}} ) {( x - {m}_{i , {L}_{j}} )}^{T} + ( {n}_{i} - {n}_{i , {L}_{j}} ) {m}_{i , {L}_{j}} {m}_{i , {L}_{j}}^{T} )$$
$${R}_{W , jk} = {\sum }_{i = 1}^{c} ( {\sum }_{x ∈ {C}_{i} , {L}_{j}} - ( x - {m}_{i , {L}_{j}} ) {m}_{i , {L}_{k}}^{T} )$$
$${T}_{W , jkl} = {\sum }_{i = 1}^{c} ( {\sum }_{x ∈ {C}_{i} , {L}_{j}} {m}_{i , {L}_{k}} {m}_{i , {L}_{l}}^{T} ) .$$
where x denotes a vector corresponding to each learning image, nᵢ denotes the number of learning images belonging to class (Cᵢ), m_{L}_{ₗ} and m_{L}_{ₖ} denote mean vectors of learning images belonging to a j-th local group (Lⱼ) and a k-th local group (Lₖ), respectively, m_{i,L}ⱼ denotes the mean vector of a learning image belonging to class (Cᵢ) and the j-th local group (Lⱼ), and m_{i,L}_{ₖ} denotes the mean vector of a learning image belonging to class (Cᵢ) and the k-th local group (Lₖ).

17. The method of claim 14, wherein the updating the local linear transformation function comprises:
determining an update amount of the local linear transformation function for the corresponding local group by using the partial differential function of the objective function;
updating the local linear transformation function for the corresponding local group by adding the determined update amount to the previous local linear transformation function; and
sequentially performing vector orthogonalization and vector normalization for the updated local linear transformation function.

18. The method of claim 14, wherein the performing the obtaining of the partial differential function and the updating until the updated local linear transformation function converges, comprises determining linear transformation whether the function converges according to whether the objective function reaches a saturated state with a predetermined value.

19. The method of claim 14, wherein the performing the obtaining of the partial differential function and the updating until the updated local linear transformation function converges, comprises comparing the update amount of the local linear transformation function with a predetermined threshold and according to the comparison result, determining whether the local linear transformation function converges.

20. An image recognition method using a local linear transformation function, comprising:
dividing learning images formed with a first predetermined number of classes, into a second predetermined number of local groups, generating a first mean vector and a set of local linear transformation functions for each of the divided local groups, and storing in a first database;
comparing a second mean vector of a registered image with the first mean vector of each local group stored in the first database, allocating one of the local groups to the registered image, and extracting feature vectors by vector-projecting the local linear transformation functions of the allocated local group on the registered image, and storing in a second database;
comparing a third mean vector of a recognized image with the first mean vector of each local group stored in the first database, allocating another one of the local group to the recognized image and extracting feature vectors by vector-projecting the local linear transformation function of the allocated local group on the recognized image, and
comparing the feature vectors of the recognized image with the feature vectors of the registered image stored in the second database.

21. An image recognition apparatus using local linear transformation functions, comprising:
a feature vector database which stores feature vectors that are extracted by comparing registered image vectors of a registered image with a mean vector of each local group of learning images, allocating one of the local groups to the registered image, and then vector-projecting the local linear transformation functions of the allocated local group on the registered image;
a feature vector extraction unit which compares recognized image vectors with the mean vector of each local group of learning images, allocates one of the local groups to the recognized image, and extracts feature vectors by vector-projecting the local linear transformation functions of the allocated local group on the recognized image; and
a matching unit which compares the feature vectors of the recognized image with the feature vectors of the registered image stored in the feature vector database.

22. The apparatus of claim 21, further comprising:
a dimension reduction unit which reduces the dimensions of the registered image using a principal component analysis.

23. A computer readable recording medium having embodied thereon a computer program capable of performing a method of generating a local linear transformation function, comprising:
dividing learning images formed with a first predetermined number of classes, into a second predetermined number of local groups;
generating a mean vector and a local linear transformation function for each of the divided local groups; and
storing the mean vector and local linear transformation function of each local group in a database.

24. A computer readable recording medium having embodied thereon a computer program capable of performing a method for extracting feature vectors by using local linear transformation functions, comprising:
dividing learning images formed with a first predetermined number of classes, into a second predetermined number of local groups, generating a mean vector and a local linear transformation function for each of the divided local groups, and storing in a database;
comparing input image vectors of an input image with the mean vector of each local group and allocating one of the local groups to the input image; and
extracting feature vectors by vector-projecting the local linear transformation function of the allocated local group on the input image.

25. A computer readable recording medium having embodied thereon a computer program capable of performing an image recognition method using local linear transformation functions, comprising:
dividing learning images formed with a first predetermined number of classes, into a second predetermined number of local groups, generating a first mean vector and a local linear transformation function for each of the divided local groups, and storing in a first database;
comparing a second mean vector of a registered image with the first mean vector of each local group stored in the first database, allocating one of the local groups to the registered image, and extracting feature vectors by vector-projecting the local linear transformation function of the allocated local group on the registered image and storing in a second database;
comparing a third mean vector of a recognized image with the first mean vector of each local group stored in the first database, allocating a local group to the recognized image, and extracting feature vectors by vector-projecting the local linear transformation function of the allocated local group on the recognized image and
comparing the feature vector of the recognized image with the feature vectors of the registered image stored in the second database.

26. A method of feature vector extraction from an image, comprising:
determining a local mean vector and local linear transformation function for respective groups of training images having a plurality of modalities;
determining a greatest correlation between a second mean vector of a second image and one of the local mean vectors of each group of the training images;
allocating the local mean vector and the local linear transformation function for the group with the determined greatest correlation to the second image; and
extracting the feature vectors from the second image by vector projecting the allocated local linear transformation on the second image.

27. The method of claim 26, wherein the second image is a registered image.

28. The method of claim 26, wherein the second image is a recognized image.

29. The method of claim 26, wherein the determining the local mean vector and local linear transformation function comprises determining a first local mean vector and a first local linear transformation function for a first group and a second local mean vector and a second linear transformation function for a second group.

30. The method of claim 29, wherein the determining the first and second local mean vectors and local linear transformation functions, further comprises
updating the local linear transformation function of one of the first and the second groups by using a partial differential function of an objective function, until the corresponding local linear transformation function converges; and
updating the local linear transformation function of the other of the first and the second groups by using the partial differential function of the objective function, until the corresponding local linear transformation function converges.

31. The method of claim 30, wherein each of the updating the local linear transformation functions, comprises:
initializing the local linear transformation function of the corresponding local group;
calculating first through fifth constant matrices based on the local linear transformation function and the corresponding mean vectors;
obtaining the partial differential function of the objective function by using the first through fifth constant matrices and the linear transformation function;
updating the local linear transformation function of the corresponding local group by using the partial different function of the objective function; and
performing the obtaining the partial differential function and the updating until the update of the local linear transformation functions converges.

32. The method of claim 30, wherein each of the updating the local linear transformation functions, comprises:
obtaining the partial differential function of the objective function using a lagrangian function.

33. A method of feature extraction of image data which has many modality distributions, comprising:
dividing the image data into a predetermined number of groups;
determining a local linear transformation function for each group through an iterative learning process;
extracting feature vectors of registered images and recognized images using the determined local linear transformation functions, wherein the recognized images can be determined with high accuracy.

34. The method of claim 32, wherein the image data is facial images.

35. The method of claim 32, wherein the image data is fingerprint images.

36. A computer readable recording medium having embodied thereon a computer program capable of performing a method of extracting feature vectors by using local mean vectors and local linear transformation functions, comprising:
determining the local mean vector and the local linear transformation function for respective groups of training images having a plurality of modalities;
determining a greatest correlation between a second mean vector of a second image and one of the local mean vectors of each group of the training images;
allocating the local mean vector and the local linear transformation function for the group with the determined greatest correlation to the second image; and
extracting the feature vectors from the second image by vector projecting the allocated local linear transformation on the second image.

37. A computer readable recording medium having embodied thereon a computer program capable of performing a method of extracting feature vectors by using local linear transformation functions, comprising:
dividing the image data into a predetermined number of groups;
determining the local linear transformation function for each group through an iterative learning process;
extracting feature vectors of registered images and recognized images using the determined local linear transformation functions, wherein the recognized images can be determined with high accuracy.
